(19) United States
(12) Patent Application Publication
(10) Pub. No.: US 2026/0196735 A1
(43) Pub. Date: Jul. 9, 2026

(54) FREQUENCY SELECTIVE SURFACE

(71) Applicant: LG ELECTRONICS INC., Seoul (KR)

(72) Inventors: Seungmin WOO, Seoul (KR); Byeongyong PARK, Seoul (KR)

(73) Assignee: LG ELECTRONICS INC., Seoul (KR)

(21) Appl. No.: 19/095,661

(22) Filed: Mar. 31, 2025

(30) Foreign Application Priority Data
Jan. 9, 2025 (KR) 10-2025-0003676

(51) Int. Cl. H01Q 15/00; H01Q 1/12

(52) U.S. Cl. CPC H01Q 15/002; H01Q 1/1271

(57) ABSTRACT

A frequency selective electromagnetic wave transmitting/blocking module including a substrate; and a plurality of conductive mesh target patterns on the substrate and including a first inner linear region; a second inner linear region intersecting with the first linear region; a first outer liner region and a second outer liner region centered on a midpoint of opposite sides from a center of the first inner linear region; and a third outer liner region and a fourth outer liner region centered on a midpoint of opposite sides from a center of the second inner linear region. Further, at least one of the inner linear and outer linear regions includes a conductive uneven mesh pattern having uneven length conductive lines.

### CROSS-REFERENCE TO RELATED APPLICATIONS

This application claims priority to Korean Patent Application No. 10-2025-0003676, filed in the Republic of Korea on Jan. 9, 2025, the entire contents of which are hereby expressly incorporated by reference into the present application.

### BACKGROUND

### Technical Field

Embodiments of the present disclosure relate to a surface having a pattern structure configured to transmit and block electromagnetic waves based on frequency selection.

### Discussion of the Related Art

When a metal mesh with a grid or non-grid structure, silver nano coating or low-emissivity (Low-E) coating is applied in a certain pattern on the surface of glass or an antenna, a Frequency Selective Surface (FSS) can be formed that selectively transmits certain frequencies of electromagnetic waves and blocks other specific frequencies. In more detail, FSS can be used in glass for buildings or automobiles that require security, such as electric vehicles products where glass is applied over a large area or smart homes where security is important.

In addition, the outermost line of the entire pattern of the FSS or the outermost line of one unit of the pattern is formed in a shape of a long metal straight line. This type of linear pattern enhances the frequency selective transmission/blocking performance of electromagnetic waves of the FSS and keeps the blocking frequency constat. However, if the metal linear pattern is included in the FSS, light refraction can occur, which deteriorates the visibility in glass and the accuracy of transmitted and received signals in antennas.

### SUMMARY

Accordingly, one object of the present disclosure is to solve the above-noted disadvantages of the prior art, and to provide a FSS with high frequency selective transmitting/blocking performance for incident electromagnetic waves without including the outermost line of the metal pattern including in a transparent FSS applied to glass, etc. in a linear line.

To solve the objects of the present disclosure, according to one embodiment, a frequency selective electromagnetic wave transmitting/blocking surface includes a surface formed of a conductive material in a mesh pattern; and a plurality of target patterns formed by partially removing the conductive material, and the target pattern can include a linear region having at least an area formed in an uneven shape with a plurality of protrusions.

According to another embodiment, a frequency selective electromagnetic wave transmitting/blocking glass can include glass; a mesh pattern formed of a conducive material on the glass; and a plurality of target patterns formed by partially removing the conductive material, and the target pattern can include a linear region having at least an area formed in an uneven shape with a plurality of protrusions.

Further, the frequency selective electromagnetic wave transmitting/blocking glass can further include PET (Polyethylene Terephthalate) film formed between the glass and the mesh pattern. Also, the plurality of target patterns can be formed in the same shape.

In addition, the shape of the target pattern can include two rectangular inner linear regions that are orthogonal in a cross shape while sharing a center, and a rectangular outer linear region centered on the midpoint of two opposite sides far from the center of each inner linear region. Each of the inner linear and outer linear regions can include a plurality of protrusions.

Also, the shape of the target pattern can include two rectangular inner linear regions that are orthogonal in a cross-shape while sharing a center, and a fan-shaped outer region centered on the midpoint of two opposite sides far from the center of each inner linear region, and the inner linear region can include a plurality of protrusions.

The shape of the target pattern can also include four rectangular linear regions forming four sides, and each of the four rectangular linear region can include a plurality of protrusions. Further, the mesh pattern can be formed by connecting a plurality of conductive lines in rows and columns, and the outermost line of the target pattern can be formed by cutting the conductive lines.

In addition, the mesh pattern provided on the outside of the target pattern can be modified so that a cross-shaped pattern can be repeatedly arranged by cutting all sides around the point where the rows and columns meet. Also, the protruding length R1 of the protrusion formed in at least an area of the target pattern and the length R2 in a longitudinal direction perpendicular to the protruding direction of the protrusion can be determined based on the average spacing p between the conductive lines, the average width lw of the conductive lines, and the width W of the non-protruding area of the linear region of the target pattern.

Further, the R1 and R2 can be determined to obtain a natural number that satisfies the following equation:

$$( n - 1 ) * p + ( n ) * lw \leq W \leq ( n ) * p + ( n - 1 ) * lw ,$$

to satisfy the following equation:

$$\frac{( n ) * ( p + l w ) - W}{2} \leq R 1 and p + 2 * lw \leq R 2.$$

According to the embodiment of the present disclosure, the FSS including the metal pattern of which the outermost line is not a linear line can be provided, and this can suppress light fraction, thereby improving visibility. Furthermore, the FSS according to the embodiment can maintain constant frequency selective electromagnetic wave transmission/blocking performance regardless of the location where the pattern is formed on the entire surface.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a diagram showing an uneven mesh pattern and a metal mesh pattern contrasting with the uneven mesh pattern according to one embodiment;

FIGS. 2a and 2b are diagrams showing a problem that occurs when designing a frequency selective electromagnetic wave transmission/blocking pattern by using a second metal mesh pattern of FSS;

FIG. 3 is a diagram showing an uneven mesh pattern structure of FSS and a pattern design process according to one embodiment;

FIG. 4 is a diagram showing factors to consider when applying the uneven mesh pattern of FSS;

FIG. 5a is a diagram showing a unit cell of the FSS to which a second metal mesh pattern is applied;

FIG. 5b is a diagram showing a unit cell of the FSS to which an uneven mesh pattern according to one embodiment is applied;

FIGS. 6 and 7 are diagrams showing the FSS to which an uneven mesh pattern formed on glass according to one embodiment is applied;

FIGS. 8a to 8c are graphs showing the frequency selective electromagnetic wave transmission/blocking performance of FSS based on the width change of the uneven mesh pattern and the incident angle of electromagnetic waves according to one embodiment;

FIG. 9 is a diagram showing simulation results and contrasting simulation results showing the current distribution and the FSS including the uneven mesh pattern according to one embodiment;

FIGS. 10 and 11 are diagrams showing a unit cell of FSS to which an uneven mesh pattern according to other embodiments are applied;

FIGS. 12 to 16 are graphs showing problems of FSS to which the uneven mesh pattern according to one embodiment is not applied;

FIGS. 17 to 21 are diagrams and graphs showing frequency selective electromagnetic wave transmission/blocking performance of FSS to which an uneven mesh pattern according to one embodiment is applied;

FIG. 22 is a diagram showing the effect of improving visibility of FSS to which an uneven mesh pattern according to one embodiment is applied, compared to a case in which the FSS according to one embodiment is not applied; and

FIG. 23 is a diagram showing a unit cell of various types of FSS to which an uneven mesh pattern according to one embodiment is applied.

### DETAILED DESCRIPTION OF THE EMBODIMENTS

Description will now be given in detail according to exemplary embodiments disclosed herein, with reference to the accompanying drawings. For the sake of brief description with reference to the drawings, the same or equivalent components can be provided with the same reference numbers, and description thereof will not be repeated.

Description will now be given in detail according to exemplary embodiments disclosed herein, with reference to the accompanying drawings. Throughout the disclosure, when an element (e.g., region, layer, portion, etc.) is referred to as being “connected with”, “on” or “coupled to” another element, the element can be directly connected with the other element or intervening elements can also be present. In contrast, when an element is referred to as being “directly connected with” another element, there are no intervening elements present.

Terms such as “comprise” or “comprising” are used herein and should be understood that they are intended to indicate an existence of several components, functions or steps, disclosed in the specification, and it is also understood that greater or fewer components, functions, or steps can likewise be utilized. Although the terms first, second, etc. can be used herein to describe various elements, these elements should not be limited by these terms.

These terms are generally only used to distinguish one element from another. It will be understood that the terms “first” and “second” are used herein to describe various components but these components should not be limited by these terms. The above terms are used only to distinguish one component from another. For example, a first component can be referred to as a second component and vice versa without departing from the scope of the invention. The singular expressions include plural expressions unless the context clearly dictates otherwise.

The terms ‘part’ or ‘module’ used in embodiments can mean a software or hardware element such as an FPGA or ASIC, and the ‘part’ or ‘module’ can perform predetermined roles. However, ‘part’ or ‘module’ is not limited to the software or hardware. The “part” or “module” can be provided in an addressable storage medium and configured to cause one or more processors to execute. Accordingly, as one example, a “part” or “module” can include elements such as software elements, object-oriented software elements, class elements and task elements, as well as processes, functions, attributes, procedures, subroutines, segments of program code, drivers, firmware, microcode, circuitry, data, database, data structures, tables, arrays and variables. The functions provided within the elements and “parts” or “modules” can be combined and “sub-part” or “modules” or further separated into additional elements and “parts” or “modules.

The steps of a method or algorithm described in connection with some embodiments of the present disclosure can be directly implemented in hardware, in a software module executed by a processor, or in a combination of the two. The software module can be provided in RAM memory, flash memory, ROM memory, EPROM memory, EEPROM memory, registers, a hard disk, a removable disk, a CD-ROM, or any other form of storage medium known in the art. An exemplary storage medium can be coupled to a processor such that the processor can read information from the storage medium and write information to the storage medium. Alternatively, a recording medium can be integral with the processor. The processor and the recording medium can be provided in an application specific integrated circuit ASIC. The ASIC can be provided in a user terminal.

Hereinafter, referring to the accompanying drawings, embodiments of the present disclosure will be described in detail, to be understood by those skilled in the art to which the present disclosure pertains. However, the present disclosure can be embodied in various modified examples and is not limited to embodiments described herein.

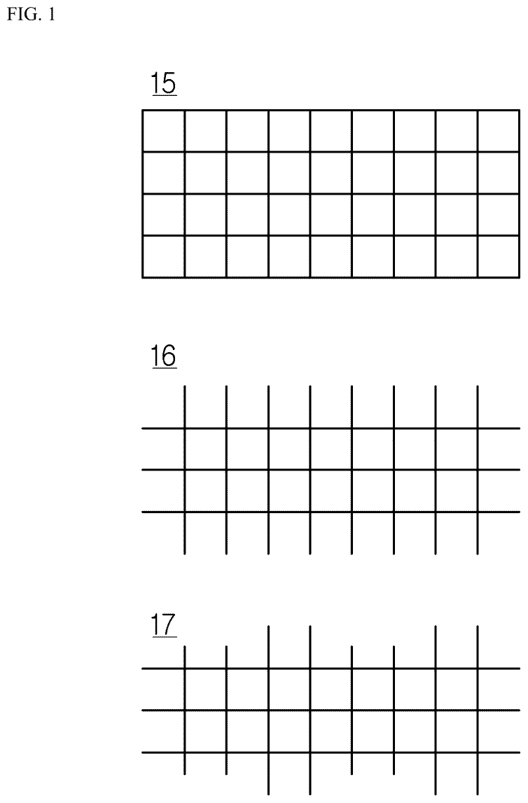

FIG. 1 is a diagram showing a metal mesh pattern contrasting an uneven mesh pattern according to one embodiment. in particular, if a regular pattern is formed with a metal material on the surface of an object that needs to selectively transmit/block electromagnetic waves such as glass or an antenna, an effect of transmitting a specific frequency band of electromagnetic waves and blocking another specific frequency band can be obtained.

When the metal pattern is formed on a material such as glass that must ensure transparency, a conductive conductor such as a metal can be thinly applied and deposited. The conductive conductor such as a metal thinly applied and deposited can function as a transparent electrode material that ensures transparency, and the formed metal area can generate an induced current when an electromagnetic wave is incident thereon, thereby blocking electromagnetic waves of a specific frequency band. Further, the pattern formed by thinly applying and depositing metal in the form of multiple intersecting lines can be referred to as a metal mesh pattern. Also, the mesh metal can have various forms, such as an orthogonal mesh (or rectangular mesh) in which multiple lines of thin metal materials are arranged in rows and columns at right angles to each other, and an irregular mesh in which multiple linear shapes are arranged without following a specific rule.

In addition to the metal mesh pattern, it is also possible to form a frequency selective electromagnetic wave transmission/blocking pattern by applying and depositing silver nanoparticles or Low-E films in a certain pattern on the surface of glass, an antenna, etc. In particular, the surface of glass or antenna to which the frequency selective electromagnetic wave transmitting/blocking pattern is applied, such as a metal mesh pattern, silver nano pattern, or Low-E film pattern can be referred to as Frequency Selective Surface (FSS). Induced current occurs in a conductor region of the metal mesh pattern, silver nano pattern or Low-E film pattern on the FSS, when an electromagnetic wave is incident. Accordingly, an electromagnetic wave blocking effect can be obtained by canceling the electromagnetic wave. Also, the intensity of the induced current can resonate and be formed differently for each frequency range based on the pattern shape, thereby allowing the electromagnetic waves of a specific frequency band to be transmitted and the electromagnetic waves of another specific frequency band to be blocked.

Generally, to improve the efficiency of the process, the FSS formation process can use a method in which the metal mesh pattern, silver nano pattern, or Low-E film pattern described above is uniformly formed over the entire surface, and then a portion of the formed pattern is removed to form a pattern of a specific shape that matches the frequency band to be blocked.

Referring to FIG. 1, the metal mesh pattern can be formed as a first metal mesh pattern 15 including an outermost line with a linear structure. In this instance, light refraction can occur due to the outermost line region. If the first metal mesh pattern 15 is applied, the user's visibility might deteriorate. In addition, the metal mesh pattern can be formed as a second metal mesh pattern 16 including no outermost line with the linear structure. In this instance, the visibility deterioration that could occur in the structure of the first metal mesh pattern 15 can be improved significantly, but when the frequency selective electromagnetic wave transmission/blocking pattern is formed on some of the entire surface, a problem can arise where the electromagnetic wave transmission/blocking performance differs based on the location where the pattern is formed.

To solve this problem, an uneven mesh pattern 17 according to one embodiment can be formed. As shown in FIG. 1, the uneven mesh pattern 17 does not have the linear structured outermost line shown in FIG. 1, and in a region corresponding to the outermost line of the first metal mesh pattern 15, a short metal line region and a long metal region are formed in a repetitive, uneven shape in which the outermost outline protrudes and recedes alternatively. Further, as shown in FIG. 1, the uneven mesh pattern 17 can have two short metal line regions and two long metal lines regions that are arranged alternatively. However, the form of the uneven mesh pattern 17 is not limited thereto, and can have n1 short metal line regions and n2 long metal line regions, which are arranged alternatively (n1, n2 are natural numbers greater or equal to 1). In addition, the uneven mesh pattern 17 can be formed only in one facing region or can be formed in all facing regions. Because the uneven mesh pattern 17 is applied to the FSS, it is possible to secure a constant electromagnetic wave transmitting/blocking performance regardless of the position where the pattern is formed and the visibility is also improved.

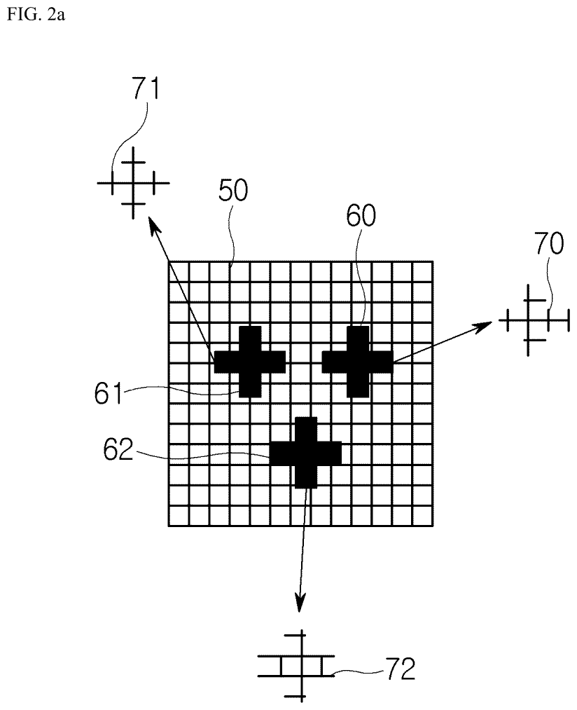

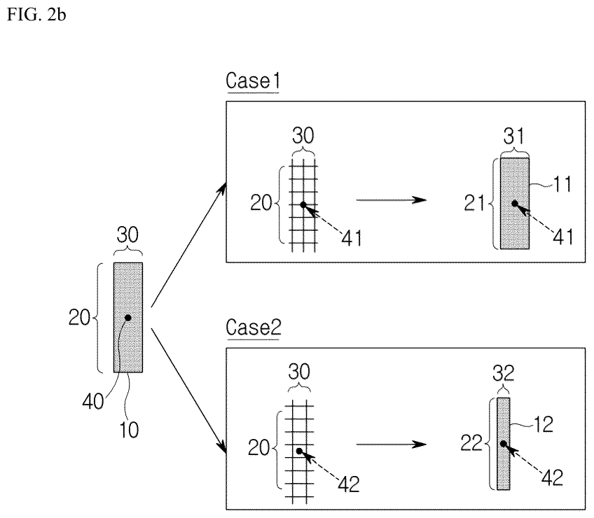

Next, FIGS. 2a and 2b are diagrams showing a problem that occurs when designing a frequency selective electromagnetic wave transmission/blocking pattern by using a second metal mesh pattern of FSS. In particular, FIG. 2a shows the process of forming first to third target patterns 60, 61 and 62 in the same cross shape on the metal mesh pattern 50 formed on the entire surface of glass or an antenna. Here, forming the target patterns include cutting the metal mesh pattern 50 along the outermost line of the target pattern. As an additional embodiment, while cutting the metal mesh pattern 50 along the outermost line of the target pattern, the outermost line of the mesh pattern 50 can remain and not be cut (see the outermost line of the mesh pattern 15 in FIG. 1).

As shown in FIG. 2a, the paths along which the induced currents of the first to third actual patterns 70, 71 and 72 flow can be formed differently based on the formation positions of the first to third target patterns 60, 61 and 62. Accordingly, when designing the first to third target patterns 60, 61 and 62, a problem might arise where the performance of transmitting/blocking electromagnetic waves of the a targeted band differs based on the pattern formation location.

Next, FIG. 2b shows a process of forming a constant frequency selective electromagnetic wave transmission/blocking pattern on the second mesh pattern 16 formed with an orthogonal mesh structure. As one example, FIG. 2b shows the target pattern 10 having a rectangular shape, with the vertical length 20, horizontal length 30, and center point 40. In the FSS formation process described above, the metal mesh pattern can be formed on the entire surface. Accordingly, when forming the target pattern 10 on the second metal mesh pattern 16 (FIG. 1) formed in the entire region, the center point 41 can be located on the metal line as in the first case Case1, or the center point 42 may not be located on the metal line as in the second case Case2, as shown in FIG. 2b.

In addition, the first actual pattern 11 of the first case Case1 and the second actual pattern 12 of the second case Case2 includes a pattern structure that produces a practical electromagnetic wave transmitting/blocking effect based on the outermost path of the induced current caused by the incident electromagnetic wave. The shape and size of the outermost metal region where the induced current is formed in the formed pattern directly affects the performance of frequency selective electromagnetic wave transmission/blocking. As shown, there is not a large difference in the vertical length 21 and 22 of the pattern, but the horizontal length 31 and 32 of the pattern is different. Accordingly, when designing the target pattern 10, a problem might arise where the performance of transmitting/blocking electromagnetic waves of the targeted band can differ based on the pattern formation location. Further, FIGS. 2a and 2b show the process of forming a regular or cross-shaped pattern on the metal mesh pattern, but the same problem might occur when forming patterns of other shapes on the metal mesh pattern, a silver nano pattern, or Low-E film pattern.

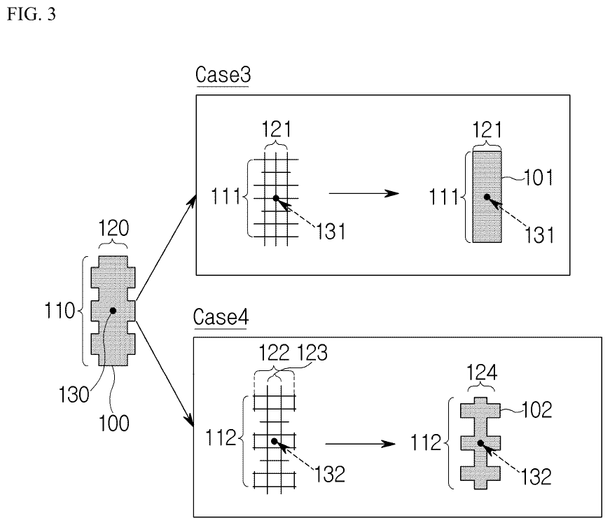

Next, FIG. 3 is a diagram showing an uneven mesh pattern structure of an FSS and a pattern design process according to one embodiment. Referring to FIG. 3, some portion of the open region of the mesh pattern can have a protruding structure and another portion of the open region can have a less protruding structure. That is, the target pattern 100 can be set to have a shape corresponding to this uneven mesh pattern 17, and the vertical length 110, horizontal length 120, and center point 130 of the target pattern can be set. The metal mesh pattern can be formed on the constant surface in the FSS formation process. Accordingly, when the target pattern 100 is formed on the metal mesh pattern formed on the entire surface, the center point 131 can be located on the metal line as in a third case Case3, or the center point 132 may not be located on the metal line as in a fourth case Case4.

In addition, the third actual pattern 101 of the third case Case3 and the fourth actual pattern 102 of the fourth case Case4 include a pattern structure that produces a practical electromagnetic wave transmitting/blocking effect based on the outermost path of the induced current caused by the incident electromagnetic wave. As shown in FIG. 3, there is not a large difference in the vertical lengths 111 and 112 of the pattern. Further, the horizontal length 124 of the fourth actual pattern 102 can be an average of the short horizontal length 123 and the long horizontal length 122 of the uneven mesh pattern on which the fourth actual pattern 102 is formed. Accordingly, although the third actual pattern 101 and the fourth actual pattern 102 have different shapes, the region of the outermost metal region through which the induced current due to electromagnetic waves flows is the same, so that the electromagnetic wave transmitting/blocking performance of a specific frequency can be maintained consistently regardless of the pattern formation location.

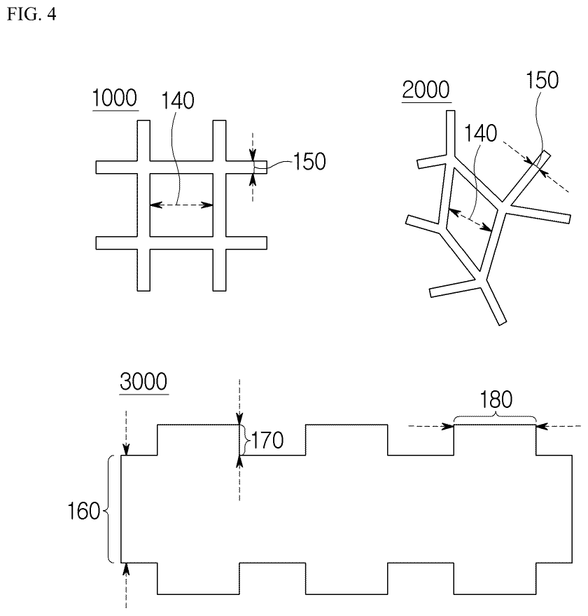

Next, FIG. 4 is a diagram showing factors to consider when applying the uneven mesh pattern of the FSS. Referring to FIG. 4, in the orthogonal mesh shaped mesh pattern 1000, the spacing between the conductive region formed of metal forming each row and each column can be defined as a pitch 140. Further, the width of the conductive region forming one line of the mesh pattern 1000 in the orthogonal shaped mesh pattern 1000 can be defined as the line width lw 150. Correspondingly, the average spacing between the conductive regions of a mesh pattern 2000 in an irregular mesh shape can be defined as a pitch 140, and the width of the conductive region forming one line of the mesh pattern 2000 in an irregular mesh shape can be defined as a line width 150.

In addition, FIG. 4 shows a target pattern 3000 having a protrusion capable of forming the uneven mesh pattern 17 (FIG. 1). When cutting the orthogonal mesh pattern 1000 along the outermost line of the target pattern 3000 including the protrusion, the target pattern 3000 can be formed on the surface. In addition, the uneven mesh pattern 17 can be formed inside the target pattern 3000 surrounded by the outermost line of the target pattern 3000.

FIG. 4 also shows a rectangular target pattern 3000 having a protrusion. As shown, a mesh pattern is cut along the outermost line of the rectangular target pattern 3000, and the mesh pattern can protrude from the protrusion, so that the uneven mesh pattern 170 can be formed. Further, in the rectangular target pattern 3000 having the protrusion, the width of the non-protruding region can be defined as the width W 160. Also, in the rectangular target pattern 3000 having the protrusion, the protruding length of the protrusion can be defined as R1 170.

In addition, as shown in FIG. 4, the length in the longitudinal direction perpendicular to the protrusion direction of the protrusion in the target pattern 3000 can be defined as R2 180. Accordingly, if the target pattern 30000 protrudes equally in both directions, the width of the protruding portion of the target pattern 3000 can be W+2R1. The above-mentioned widths 160, R1 170, and R2 180 can be calculated by measuring the corresponding values in several regions and then taking the average for the uneven mesh pattern with the irregular mesh structure.

In more detail, the shape of the target pattern 3000 can be determined by following mathematical equations 1, 2, and 3. Further, the pitch 140, is represented as p, the line width 150 is represented as lw, and the width 160 is represented as W.

$$( n ‐ 1 ) * p + ( n ) * lw \leq W \leq ( n ) * p + ( n - 1 ) * lw \qquad ( Mathematical Formula 1 )$$

By substituting the pitch p 140, the line width lw 150, and the width W 160 into the above mathematical formula, ‘n’ which is a natural number greater than or equal to 1 can be obtained.

$$\frac{( n ) * ( p + l w ) - W}{2} \leq R 1 \qquad ( Mathematical Formula 2 )$$

$$p + 2 * lw \leq R 2 \qquad ( Mathematical Formula 3 )$$

In addition, the range of R1 and R2 can be obtained by substituting ‘n’ obtained from the mathematical formula 1 into the mathematical formulas 2 and 3. When the protrusion of the target pattern 3000 is formed within the calculated range of R1 and R2 calculated, the frequency-selective electromagnetic wave transmitting/blocking performance can be secured regardless of the position at which the target pattern is formed. For example, the minimum R1 170 that can secure the frequency selective electromagnetic wave transmitting/blocking performance of the uneven mesh pattern 3000 with the pitch 140 of 200 μm, the line width (150) of 20 μm, and the width (160) of 0.5 mm is 0.08 mm and the minimum R2 (180) is 0.3 mm.

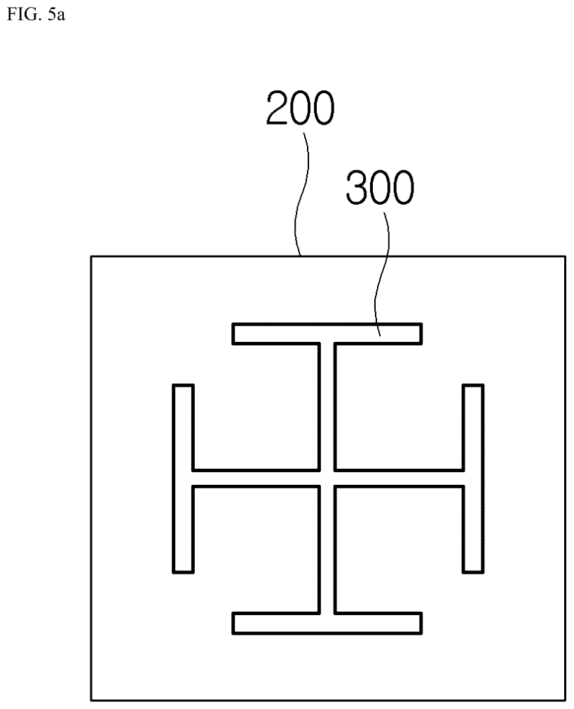

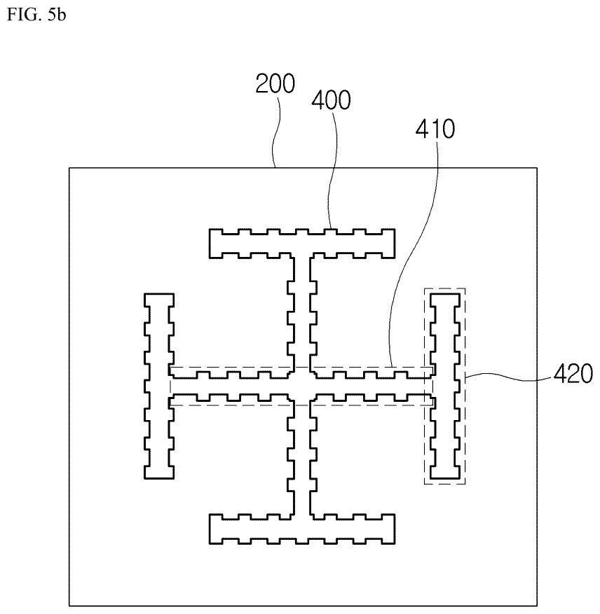

Next, FIG. 5a is a diagram showing a unit cell of the FSS to which a second metal mesh pattern 16 is applied. Referring to FIG. 5a, the frequency selective electromagnetic wave transmitting/blocking pattern 300 can be formed in a unit cell 200, which is a unit of a pattern repeatedly arranged on the surface of the FSS. The frequency selective electromagnetic wave transmitting/blocking pattern 300 includes the path of the induced current for electromagnetic wave incidence on the second metal mesh pattern 16.

Further, the frequency selective electromagnetic wave transmitting/blocking pattern 300 to which the second metal mesh pattern 16 is applied can obtain the effect of improving visibility by eliminating the light refraction effect. However, there is a problem because the frequency selective electromagnetic wave transmitting/blocking performance can differ based on the part of the pattern, as shown in FIGS. 2a and 2b, based on the region where the pattern is formed.

Next, FIG. 5b is a diagram showing a unit cell of the FSS to which an uneven mesh pattern according to one embodiment is applied. Referring to FIG. 5b, the first target pattern 400 can be formed in a unit cell which is one unit of the pattern repeatedly arranged on the surface of FSS. The first target pattern 400 can be shown as the path of movement of the induced current when the electromagnetic wave is incident on the uneven mesh pattern 17 according to one embodiment.

Further, the first target pattern 400 can include an inner linear region 410 and an outer linear region 420. In the first target pattern 400, a cross-shaped region can be formed at the center as shown. In addition, the cross-shaped region can be formed by intersecting two inner linear regions 410. Also, the outer linear region 420 orthogonal to the center of the inner linear region 410 can be formed at the two portions furthest away from the center of the inner linear region 410. The uneven mesh pattern 17 according to one embodiment can be formed in the inner linear region 410 and the outer linear region 420, so that the first target pattern 400 can maintain the frequency selective electromagnetic wave transmitting/blocking performance in each part of the pattern at a constant level regardless of the region where the pattern is formed, as shown in FIG. 3, in addition to improving the visibility.

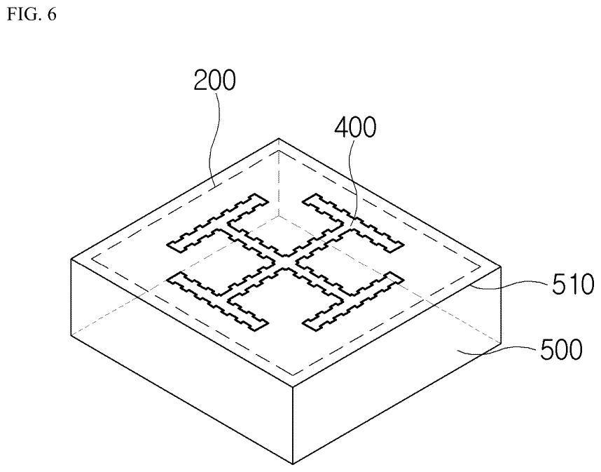

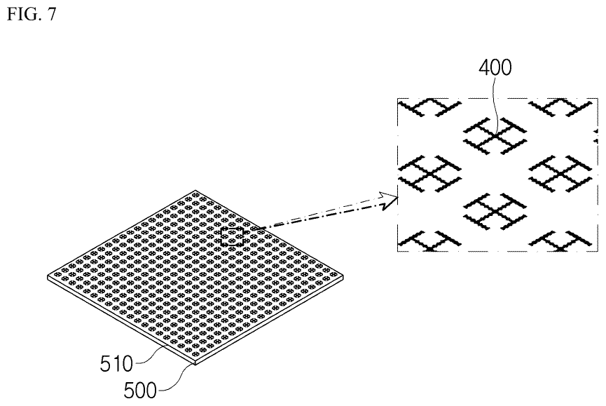

Next, FIGS. 6 and 7 are diagrams showing the FSS to which an uneven mesh pattern formed on glass according to one embodiment is applied. Referring to FIG. 6, the first target pattern 400 can be formed on a polyethylene Terephthalate PET film 510 deposited on the glass 500 (e.g., a FSS module). According to one embodiment, the first target pattern 400 can be formed by depositing a metal material in a constant shape directly on the glass 500 without the PED film 51. FIG. 6 shows only a region of the glass 500 on which the unit cell 200 is disposed, but as shown in FIG. 7, the FSS can include a surface structure including a plurality of first target patterns 400 by repeatedly disposing a plurality of unit cells 200 in the wide region of the glass 500.

Referring to FIG. 7, the first target pattern 400 can be repeatedly formed on the PED film 500 deposited on the glass 500. In FIG. 7, the plurality of first target patterns 400 can be arranged in rows and columns regularly. However, the first target patterns 400 can be arranged irregularly on the PET film 510 or arranged regularly in another manner. In addition, the first target pattern 400 regularly arranged can provide a certain frequency selective transmitting/blocking performance for electromagnetic waves incident at various angles from various directions.

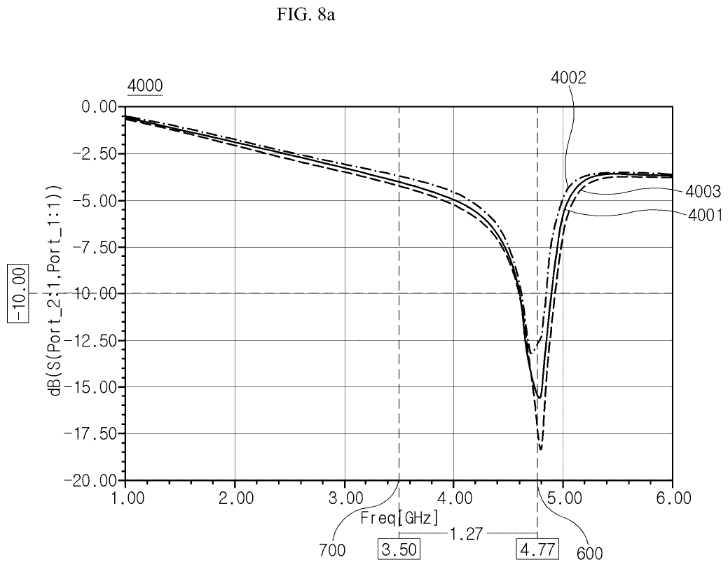

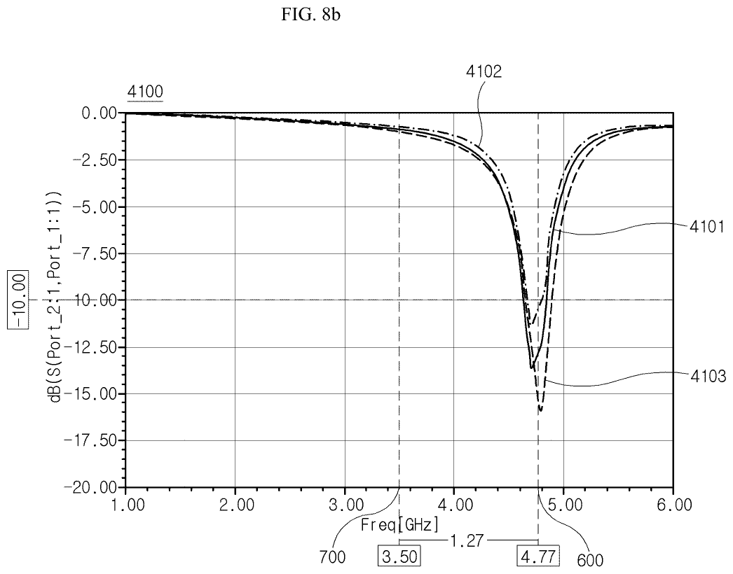

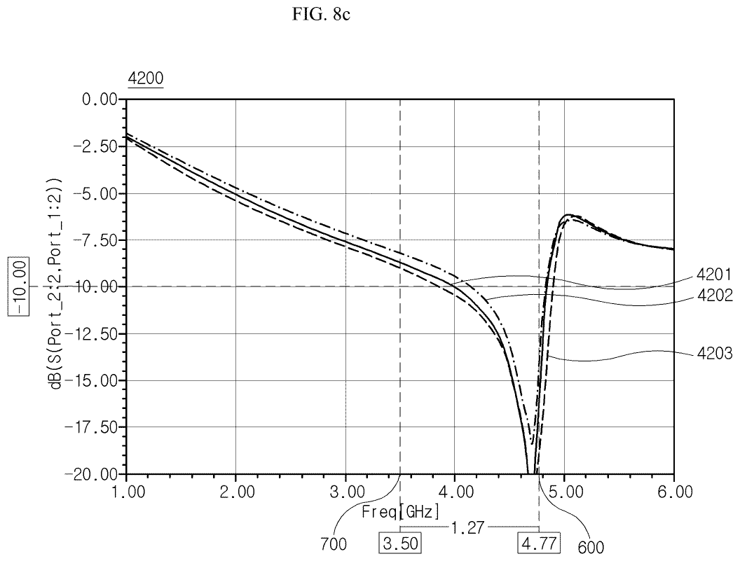

Next, FIGS. 8a to 8c are graphs showing the frequency selective electromagnetic wave transmission/blocking performance of FSS based on the width change of the uneven mesh pattern and the incident angle of electromagnetic waves according to one embodiment. In particular, FIGS. 8a to 8c are graphs showing the transmitting/blocking performance based on the electromagnetic wave incidence angle when the width 150 of the uneven mesh pattern 17 of the first target pattern 400 is set to 0.5 mm (hereinafter, referred to as the first width pattern), when the width 160 when the width 160 of the uneven mesh pattern 17 of the first target pattern 400 is set to 0.36 mm (hereinafter referred to as the second width pattern), and when the width 160 of the uneven mesh pattern 17 of the first target pattern 400 is set to 0.64 mm (hereinafter referred to as the third width pattern).

Further, the pitch 140 is set to 200 μm, the line width 150 is set to 20 μm, and R1 170 and R2 180 are assumed to be the minimum values based on mathematical formulas 1 to 3 according to the corresponding values. In addition, the center frequency of the frequency band to be transmitted is set to 3.5 GHZ, and the center frequency of the frequency band to be blocked is set to 4.77 GHz. Also, 3.5 GHz can be defined as the transmission frequency 700 and 4.77 GHz can be defined as the blocking frequency 600.

Referring to FIG. 8a, in Graph 1 4000 showing the transmitting/blocking performance when an electromagnetic wave is incident directly on the FSS (incident angle is 0 degrees), the electromagnetic wave transmitting/blocking result of the first width pattern 4001, the electromagnetic wave transmitting/blocking result of the second width pattern 4002, and the electromagnetic wave transmitting/blocking result of the third width pattern 4004 are shown. The x-axis of Graph 1 4000 represents the frequency of electromagnetic waves (unit: GHz), and the y-axis represents the degree of electromagnetic wave blocking (unit: dB). Referring to Graph 1 4000, although there is a difference in the degree depending on the width 160 of the uneven mesh pattern 17, all of the first to third width patterns can obtain a high electromagnetic wave blocking effect of 10 dB or more near the blocking frequency 600, and a low electromagnetic wave blocking effect of 5 dB or less near the transmission frequency 700.

FIGS. 8b and 8c are graphs showing the results of electromagnetic wave transmitting/blocking when the TM mode (Transverse Magnetic Mode) component and the TE mode (Transverse Electric Mode) component of the electromagnetic wave are incident, respectively. When an electromagnetic wave travels through a medium boundary between two media, an incident plane that is perpendicular to the medium boundary and contains the electromagnetic wave can be defined.

Further, electromagnetic waves can have all polarized vibrations of 360 degrees with respect to the direction of propagation. Also, the vibration component that is included in the incident plane and perpendicular to the direction of propagation of the electromagnetic wave can be defined as the TM mode, and the vibration component that is perpendicular to both the incident plane and the direction of propagation of the electromagnetic wave can be defined as the TE mode. Both the TE mode components and the TM mode components of electromagnetic waves show similar transmission tendencies when incident on the FSS, but generally, the degree to which the TE mode component is blocked is greater. However, when an electromagnetic wave is incident on the FSS at an incidence angle of 0 degrees from the front, the degree to which the TE mode and TM mode components are blocked is the same.

Referring to FIG. 8b, in Graph 2 4100 showing the transmitting/blocking performance of the TM mode component when an electromagnetic wave is incident on the FSS at an incident angle of 60 degrees, the electromagnetic wave transmitting/blocking result of the first width pattern 4101, the electromagnetic wave transmitting/blocking result of the second width pattern 4102, and the electromagnetic wave transmitting/blocking result of the third width pattern 4103 are shown. As shown, the x-axis of Graph 2 4100 represents the frequency of electromagnetic waves (unit: GHz), and the y-axis represents the degree of electromagnetic wave blocking (unit: dB). Referring to Graph 2 4100, similar to Graph 1 4000, there is a difference in the degree based on the width 160 of the uneven mesh pattern 17, but all of the first to third width patterns can obtain a high electromagnetic wave blocking effect of 10 dB or more near the blocking frequency 600, and a low electromagnetic wave blocking effect of 5 dB or less near the penetration frequency 700.

Referring to FIG. 8c, in Graph 3 4200 showing the transmitting/blocking performance of the TE mode component when the electromagnetic wave is incident at an angle of 60 degrees to the FSS, the electromagnetic wave transmitting/blocking result of the first width pattern 4201, the electromagnetic wave transmission/blocking result of the second width pattern 4202, and the electromagnetic wave transmitting/blocking result of the third width pattern 4203 are shown. As shown, the x-axis of Graph 3 4200 represents the frequency of electromagnetic waves (unit: GHz), and the y-axis represents the degree of electromagnetic wave blocking (unit: dB). Referring to Graph 3 4200, although there is a difference in the degree based on the width 160 of the uneven mesh pattern 17, all of the first to third width patterns can obtain a high electromagnetic wave blocking effect of 10 dB or more near the blocking frequency 600, and a low electromagnetic wave blocking effect of 10 dB or less near the transmission frequency 700.

As described above, even if the width 160 of the first target pattern 400 changes, when the uneven mesh pattern 17 is formed while maintaining the range of R1 170 and R2 180 according to Mathematical Formulas 1 to 3, a constant frequency selective transmitting/blocking performance can be maintained for electromagnetic waves incident at various angles.

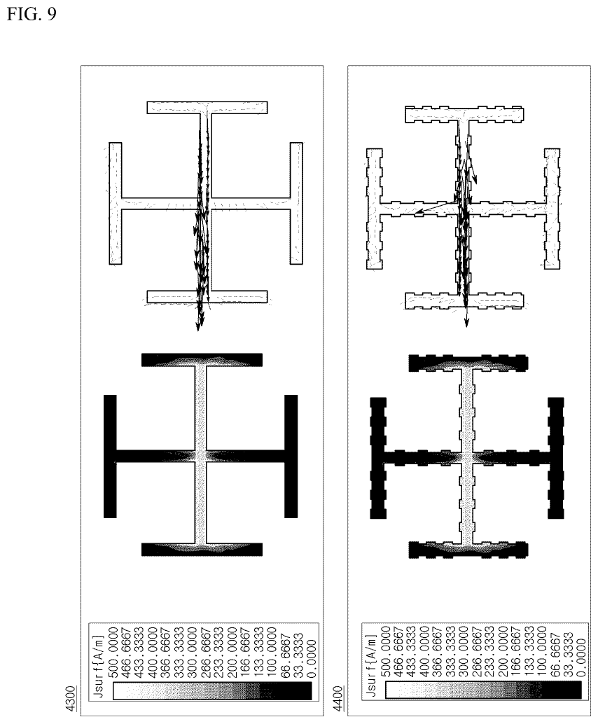

Next, FIG. 9 is a diagram showing simulation results and contrasting simulation results of the current distribution and the FSS including the uneven mesh pattern according to one embodiment. In particular, FIG. 9 illustrates a Result 1 4300, which is a simulation result of the induced current distribution for the incident electromagnetic wave of the frequency-selective electromagnetic wave transmitting/blocking pattern 300 (FIG. 5a), and a Result 2 4400, which is a simulation result of the induced current distribution for the incident electromagnetic wave of the first target pattern 400 (FIG. 5b). As shown, in both Result 1 4300 and Result 2 4400, a relatively strong induced current is formed in the inner linear regions of the patterns, which blocks electromagnetic waves near the blocking frequency 600. In contrast, a relatively weak induced current is formed in the outer linear region of the patterns.

Therefore, the role of the inner linear region in blocking electromagnetic waves before frequency selection is relatively large. Also, the first target pattern 400 of Result 2 4400 can be formed by distributing a strong current over a wider region by the uneven mesh pattern 17 of the inner linear region 410, which lowers the inductance formed inside the pattern and increases the blocking frequency 600. In contrast, the outer linear region 420 of the first target pattern 400 has a low current flow, but the current flows through a longer path due to the uneven mesh pattern 17, thereby lowering the blocking frequency 600.

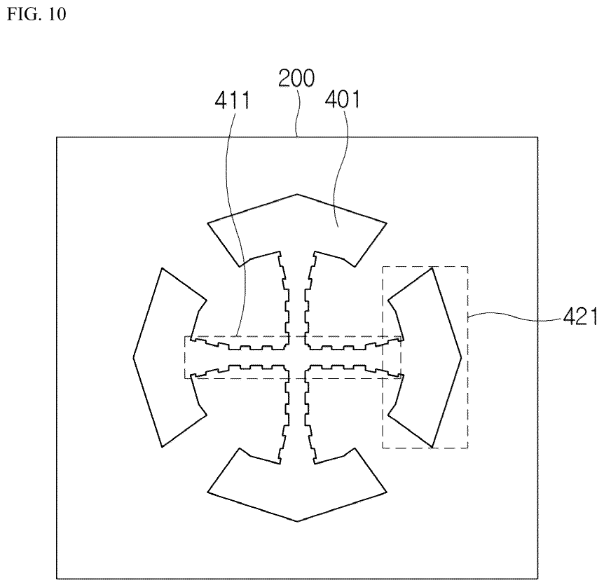

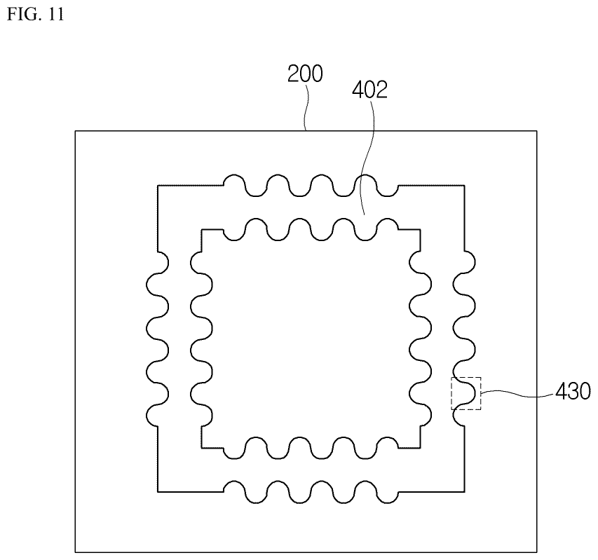

Next, FIGS. 10 and 11 are diagrams showing a unit cell of an FSS to which an uneven mesh pattern according to other embodiments are applied. Referring to FIG. 10, the second target pattern 401 is formed in a cross shape with an inner linear region 411 perpendicular to the center, similar to the first target pattern 400, and an outer region 421 formed in an area away from the center of the inner linear region 411. As shown, the outer region 421 can be designed to have a larger area and outer line length than the outer linear region 412 of the first target pattern 400.

Further, the uneven mesh pattern 17 can be applied to the inner linear region 411, and the second metal mesh pattern 16 can be applied to the outer region 421. Also, the second target pattern 401 can maintain the uneven mesh pattern 17 like the first target pattern 400 in the inner linear region 411 that has a relatively large effect on electromagnetic wave blocking, and even if the outer region 421 does not have the uneven mesh pattern 17, a long current movement path is secured, thereby obtaining a constant frequency-selective electromagnetic wave transmitting/blocking effect similar to the first target pattern 400.

Referring to FIG. 11, the third target pattern 402 can be formed by applying the uneven mesh pattern 17 to an area excluding the area near the corners of a square or rectangular pattern that has a similar relationship but different sizes and shares two centers. Further, the second metal mesh pattern 16 can be applied to an area near the corner of the third target pattern. Also, the region corresponding to each side of the third target pattern 402 can play the same role as the inner linear region 410 of the first target pattern 400 and can form a strong induced current for the incident electromagnetic wave.

Accordingly, the uneven mesh pattern 17 can be maintained in the relevant region and play a role corresponding to the outer region 421 of the second target pattern 401. In addition, the protrusion 430 by the uneven mesh pattern 17 of the third target pattern 402 can be formed in a round shape as shown, and can be formed in a partial square shape like the first target pattern 400 and the second target pattern 401. This can be equally applied to the first target pattern 400 and the second target pattern 401.

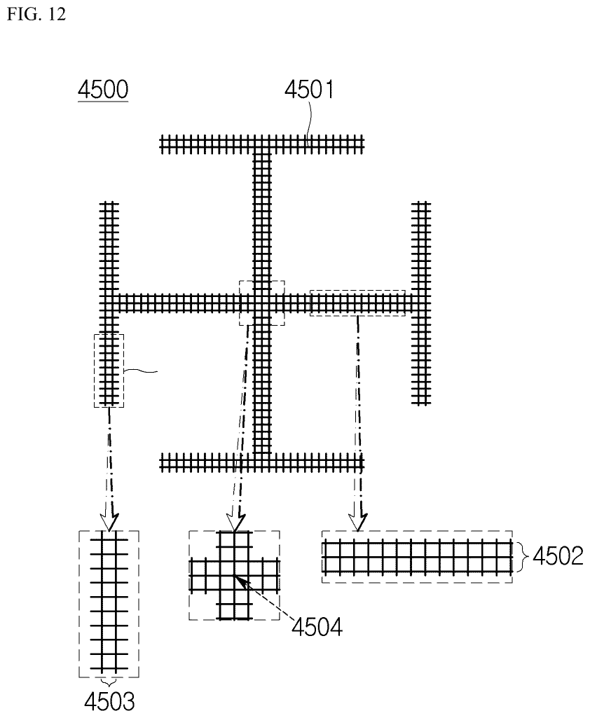

Next, FIGS. 12 to 16 are graphs showing problems of FSS to which the uneven mesh pattern according to one embodiment is not applied. In particular, FIG. 12 shows the structure of the frequency selective electromagnetic wave transmitting/blocking pattern 300 to which the second metal mesh pattern 16 is applied. The frequency selective electromagnetic wave transmitting/blocking pattern 300 shown in FIG. 12 can have the center point 4504 of the pattern positioned in a metal region, and the width 4502 of the outermost region of metal through which current flows substantially in the inner linear region 410 can be larger than the width 4503 of the outermost region of metal through which current flows substantially in the outer linear region 420. The structure shown in FIG. 12 can be referred to as the first structure 4500.

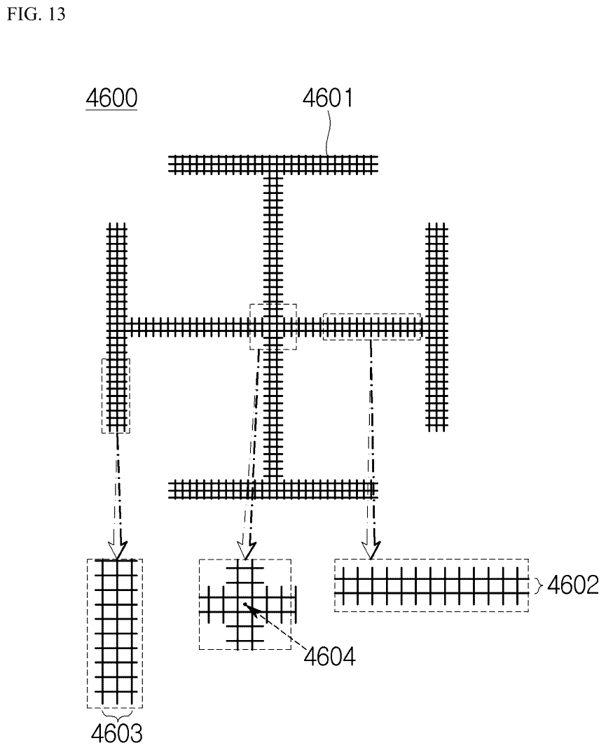

FIG. 13 shows the structure of the frequency-selective electromagnetic wave transmitting/blocking pattern 300 to which the second metal mesh pattern 16 formed at a different location from that in FIG. 12 is applied. The frequency selective electromagnetic wave transmitting/blocking pattern 300 shown in FIG. 13 can have the width 4602 of the outermost region of the metal through which current flows substantially in the inner linear region 410 since the center point 4604 of the pattern is not located in the metal region, and thus the width of the outermost region of the metal through which current flows substantially in the outer linear region 420 can be smaller than the width (4603).

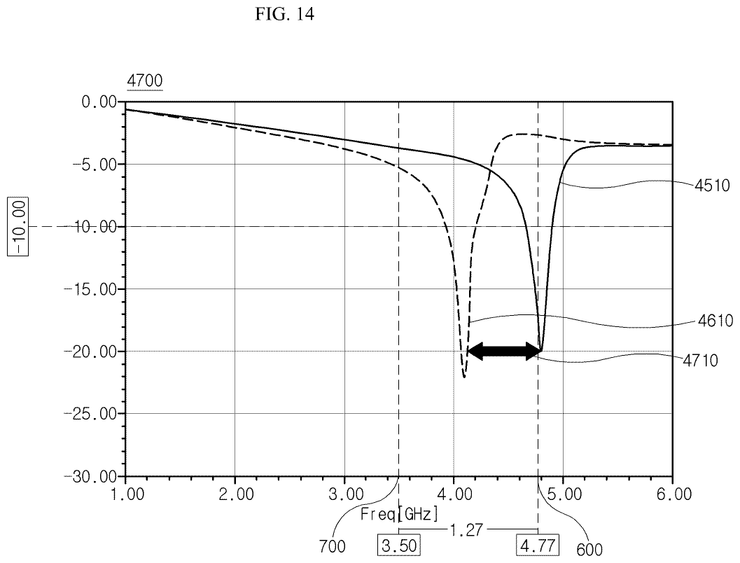

FIG. 14 is a graph 4700 showing the transmitting/blocking performance of TE and TM of the FSS having the first structure 4500 (FIG. 12) and the second structure 4600 (FIG. 13) when an electromagnetic wave is incident from the front at an incident angle of 0 degree. As shown, the Graph 4 4700 shows the electromagnetic wave transmitting/blocking result 4510 of the first structure (FIG. 12) and the electromagnetic wave transmitting/blocking result 4610 of the second structure 4600 (FIG. 13). Also, the x-axis of Graph 4 4700 represents the frequency of electromagnetic waves (unit: GHz), and the y-axis represents the degree to which electromagnetic waves are blocked (unit: dB).

As shown in the Graph 4 4700, a frequency transition 4710 occurs in which the blocking frequency 600 band changes based on the location where the pattern is formed, even for the same electromagnetic wave. This is because, as described in FIG. 1, when a pattern is designed in an arbitrary region of a general metal mesh pattern without the outermost line, the area of the region where an induced current is formed becomes different. That is, when the pattern is designed in the form of the first target pattern 400 on the general metal mesh pattern without the outermost line, each unit cell 200 can exhibit a different transmission/blocking performance in a different frequency band, and a problem of deterioration of the overall blocking or transmission performance might occur.

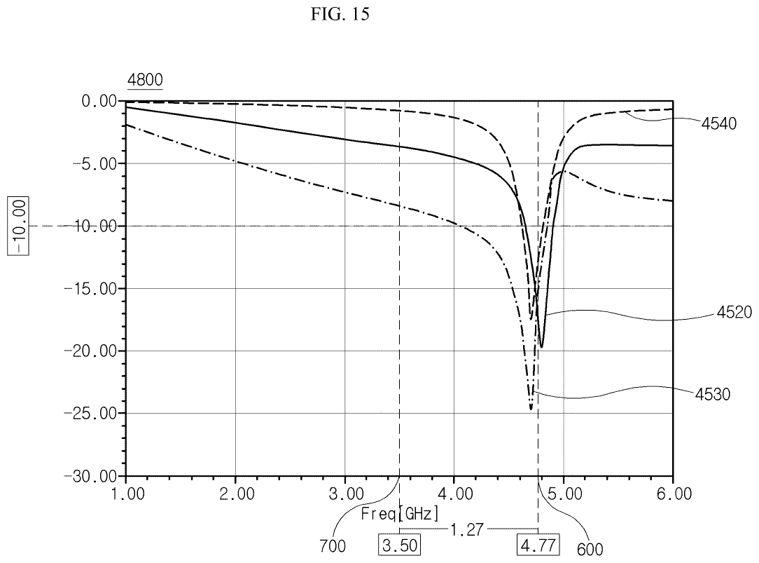

Referring to FIG. 15, Graph 5 4500 corresponding to the transmitting/blocking performance of the FSS having the first structure 4500 (FIG. 12) shows the electromagnetic wave transmitting/blocking result 4520 for the TE and TM mode ingredients of the electromagnetic wave incident on incident at an incident angle of 0 degree, the electromatic wave transmitting/blocking result 4530 for the TE mode ingredient of the electromagnetic wave incident on the FSS having the first structure 4500 at an incident angle of 60 degrees, and the transmitting/blocking result 4540 for the TM mode ingredients of the electromagnetic wave on the FSS having the first structure 4500 at an incident angle of 60 degrees. Referring to Graph 5 4800, a blocking performance of 10 dB or more is shown relatively consistently around the blocking frequency 600, and a blocking performance of 10 dB or less is shown around the transmitting frequency 700.

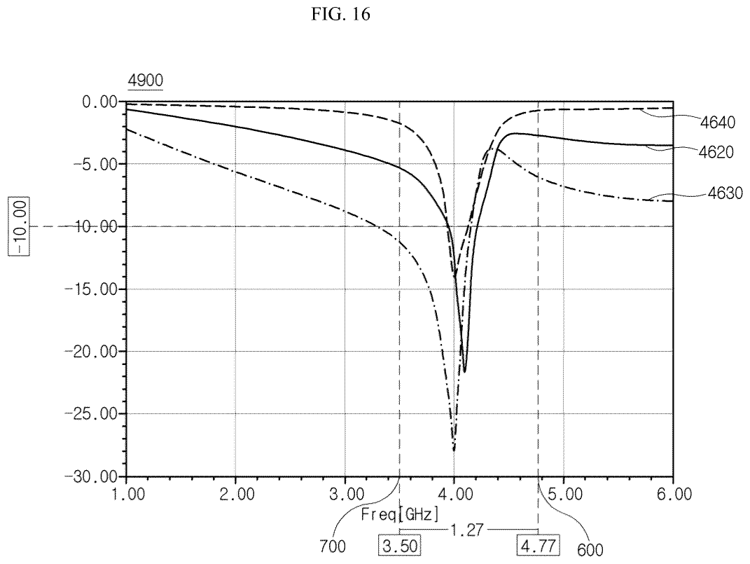

Referring to FIG. 16, Graph 6 4900 corresponding to the transmitting/blocking performance and ingredients of the FSS having the second structure 4600 (FIG. 13) shows the electromagnetic wave transmitting/blocking result 4620 for the TE and TM mode ingredients of the electromagnetic wave incident on incident at an incident angle of 0 degree, the electromatic wave transmitting/blocking result 4630 for the TE mode ingredient of the electromagnetic wave incident on the FSS having the second structure 4600 at an incident angle of 60 degrees, and the transmitting/blocking result 4640 for the TM mode ingredients of the electromagnetic wave on the FSS having the second structure 4600 at an incident angle of 60 degrees. Referring to Graph 6 4900, unlike the electromagnetic wave transmitting/blocking performance of the first structure 4500 shown in Graph 5 4800, the frequency band where the most electromagnetic waves are blocked deviates significantly from the vicinity of the blocking frequency 600, and the degree to which frequencies near the transmitting frequency 700 are blocked also increases.

Referring to FIGS. 14 to 16, the electromagnetic wave transmitting/blocking performance of the FSS in which the first structure 4500 to which the second metal mesh pattern 16 is applied and the second structure 4600 are mixed can be different for each unit cell 200 or each part inside the unit cell 200. This can cause a problem of FSS performance deterioration.

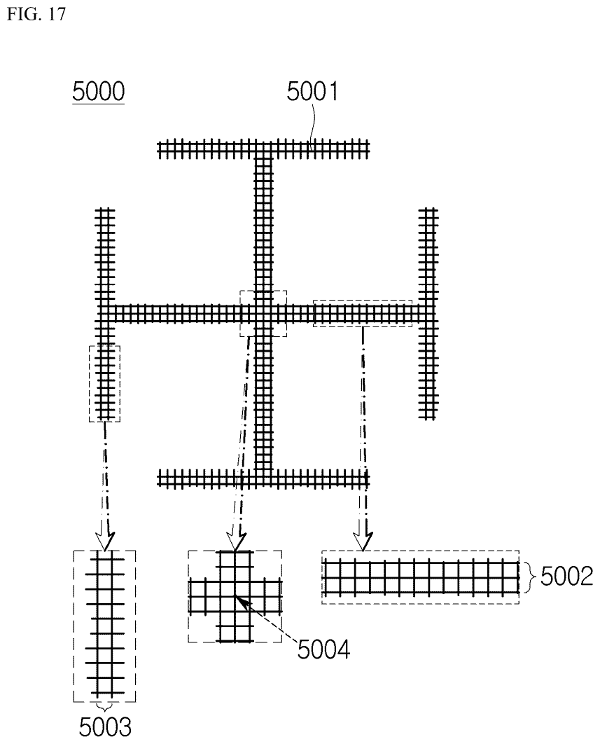

Next, FIGS. 17 to 21 are diagrams and graphs showing frequency selective electromagnetic wave transmission/blocking performance of FSS to which an uneven mesh pattern according to one embodiment is applied. In particular, FIG. 17 shows the first target pattern 400 to which the uneven mesh pattern 17 is applied. As shown, the first target pattern 400 can have the center point 5004 located in the metal region, and the width 5002 of the outermost region of the metal along which current actually flows in the inner linear region 410 can be greater than the width 5003 of the outermost region of the metal through which current actually flows inside the outer linear region 420. The structure shown in FIG. 1 can be referred to as the third structure 5000.

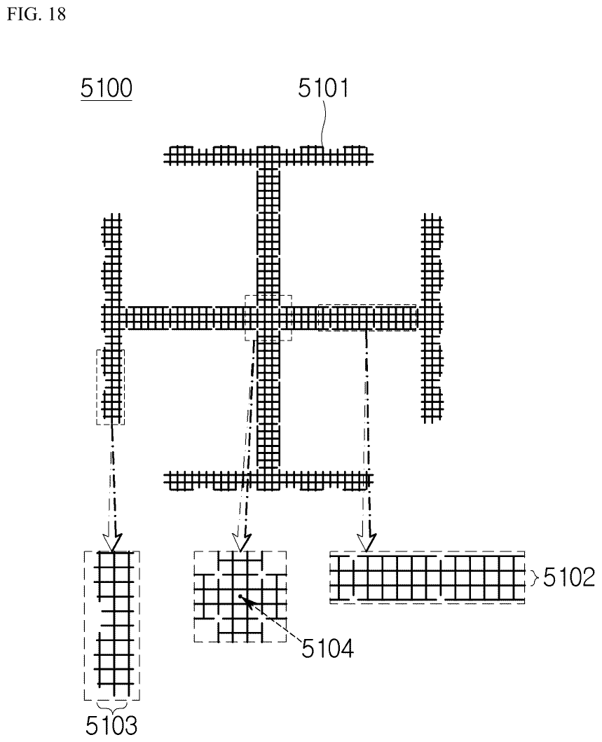

FIG. 18 shows the structure of the first target pattern 400 applied to the uneven mesh pattern 17 formed at a position that is different what is shown in FIG. 17. In the first target pattern 400 shown in FIG. 18, the center point 5104 of the pattern is not located in the metal region, and the width 5102 of the outermost region of the metal along which current actually flows inside the inner linear region 410 can be greater than the width 5103 of the outermost region of the metal along which current actually flows inside the outer linear region 420.

Referring to FIGS. 17 and 18, the width 5002 of the outermost region of the metal along which current actually flows inside the inner linear region 410 of the third structure 5000 can have a structure different from that of the width 5102 in the outermost region of the metal along which current actually flows, and there is a difference in the number of the metal region formed linearly. However, the fourth structure 5100 can obtain the effect of having the same width on average in terms of the current flow path by including the uneven mesh pattern 17. This can be equally applied to the width 5003 of the outermost region of the metal through which current flows in the outer linear region 420 of the third structure 5000 and the width 5103 of the outermost region of the metal through which current flows in the outer linear region 420 of the fourth structure 5100.

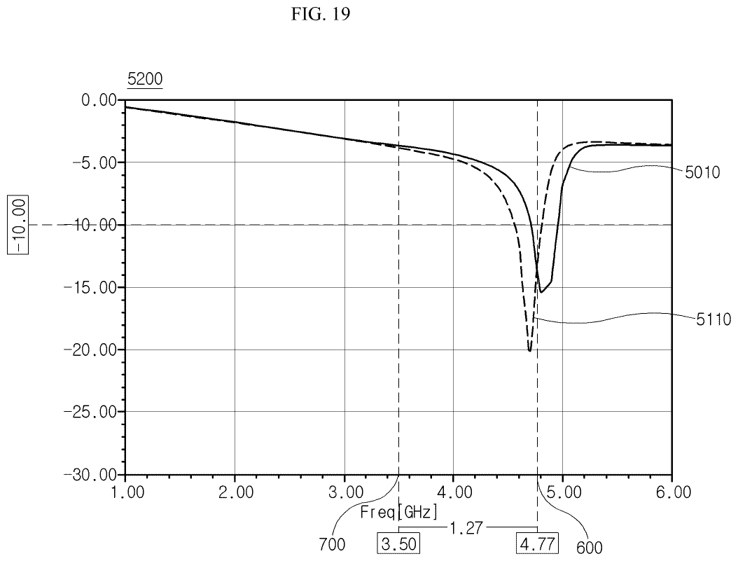

Referring to FIG. 19, the Graph 7 5200 shows the transmitting/blocking result of the TE and TM mode ingredients of the third structure 5000 and the fourth structure 5100 when an electromagnetic wave is incident on the front of the FSS at an incident angle of 0 degree, and in particular shows the electromagnetic wave transmitting/blocking result 5010 of the third structure 5000, and the electromagnetic wave transmitting/blocking result 5110 of the fourth structure 5100. Also, the x-axis of Graph 7 5200 represents the frequency of electromagnetic waves (unit: GHz), and the y-axis represents the degree to which electromagnetic waves are blocked (unit: dB).

Referring to Graph 7 5200 unlike Graph 4 4700, the frequency transition in which the blocking frequency 600 band changes depending on the location where the pattern is formed for the same electromagnetic wave hardly occurs. This is because, as described above, the uneven mesh pattern 17 is applied in the third structure 5000 and the fourth structure 5100 to make the actual current-flowing areas of the inner linear region 410 and the outer linear region 420 similar. In addition, even if the inner linear region 410 is formed with a relatively large area, if the uneven mesh pattern 17 is applied to the outer linear region 420 to relatively increase the length and area of the path through which the current moves, the effect of compensating for the large area of the inner linear region 410 can be obtained. Accordingly, as shown in Graph 7 5200, a constant frequency transmission/blocking performance can be maintained regardless of the position at which the pattern is formed.

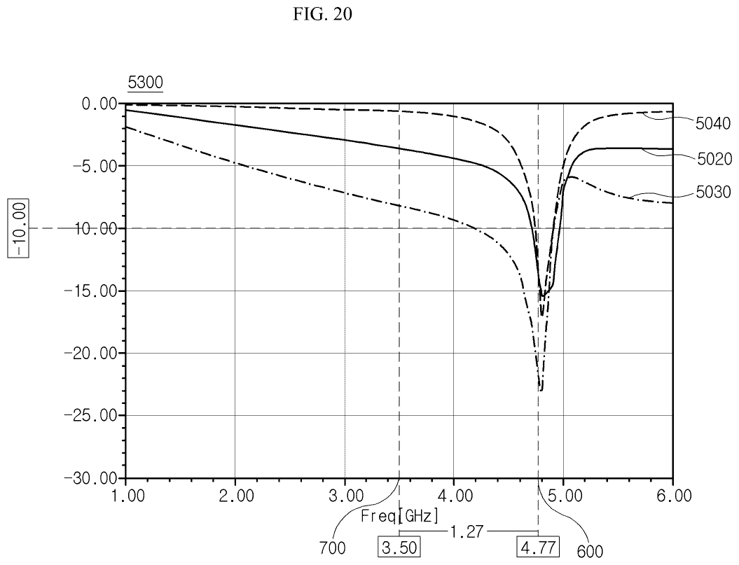

Referring to FIG. 20, Graph 8 5300 shows the electromagnetic wave transmitting/blocking performance of the third structure 5000 based on the incident angle and ingredients of electromagnetic wave, and in particular shows the transmitting/blocking result 5020 for TE and TM mode ingredients of the electromagnetic wave incident on the FSS having the third structure 5000 at an incident angle of 0 degree, the transmitting/blocking result 5030 for the TE mode ingredients of the electromagnetic wave incident on the TSS having the third structure 5000 at an incident angle of 60 degrees, and the transmitting/blocking result 5040 for the TM mode ingredients of the electromagnetic wave incident on the FSS having the third structure 5000. Referring to Graph 8 5300, a blocking performance of 10 dB or more is shown relatively consistently around the blocking frequency 600, and a blocking performance of 10 dB or less is shown around the transmission frequency 700.

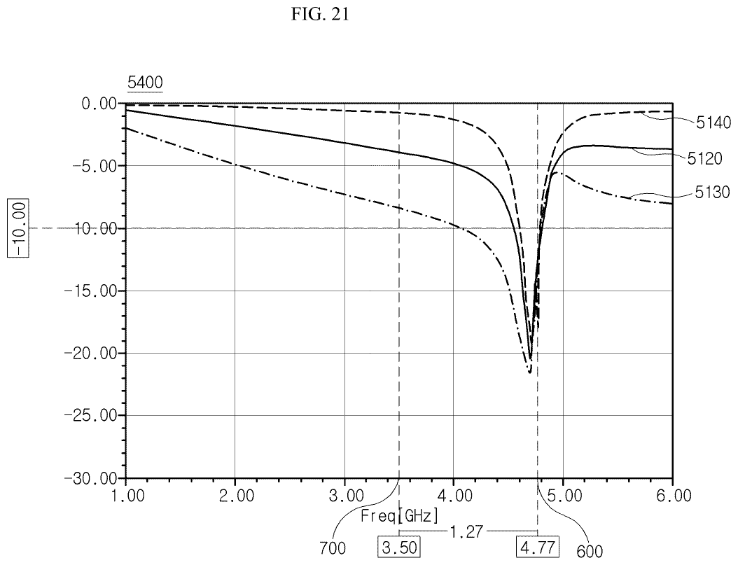

Referring to FIG. 21, Graph 9 5400 shows the transmitting/blocking performance of the fourth structure 5100 based on the incident angle and ingredients of the electromagnetic wave, and in particular shows the transmitting/blocking result 5120 for the TE and TM mode ingredients of the electromagnetic wave incident on the FSS having the fourth structure 5100 at an incident angle of 0 degrees, the transmitting/blocking result 5130 for the TE mode ingredients of the electromagnetic wave incident on the FSS having the fourth structure 5100 at an incident angle of 60 degrees, and the transmitting/blocking result 5140 for the TM mode ingredients of the electromagnetic wave incident on the FSS having the fourth structure 5100 at an incident angle of 60 degrees.

Referring to FIGS. 19 to 21, the electromagnetic wave transmitting/blocking performance of the FSS in which the third structure 5000 and the fourth structure 5100 are mixed with the uneven mesh pattern 17 can be maintained constant over the entire region of the FSS.

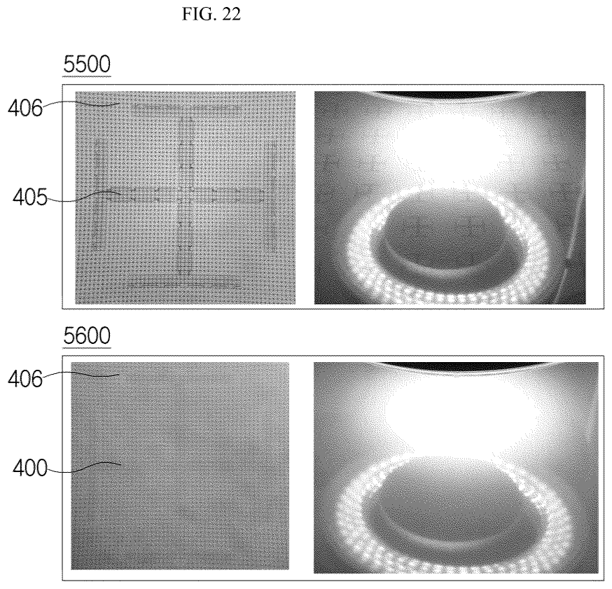

Next, FIG. 22 is a diagram showing the effect of improving the visibility of FSS to which an uneven mesh pattern according to one embodiment is applied, compared to a case in which the FSS according to one embodiment is not applied. In particular, FIG. 22 includes Result 3 5500 showing the results of a visibility experiment of a fourth target pattern 405 having a structure in which the outermost line is formed on the uneven mesh pattern 17 of the first target pattern 400, and Result 4 5600 showing the results of a visibility experiment when the first target pattern 400 (FIG. 6) to which the uneven mesh pattern 17 is applied is applied to glass.

Referring to Result 3 5500 and Result 4 5600, a dummy pattern 406 of a certain shape can be formed in an area in which the first target pattern 400 and the fourth target pattern 405 are not formed. The dummy pattern 400 can have a form in which cross-shaped patterns smaller than the first target pattern 400 and the fourth target pattern 405 are repeatedly arranged in rows and columns, which can improve visibility.

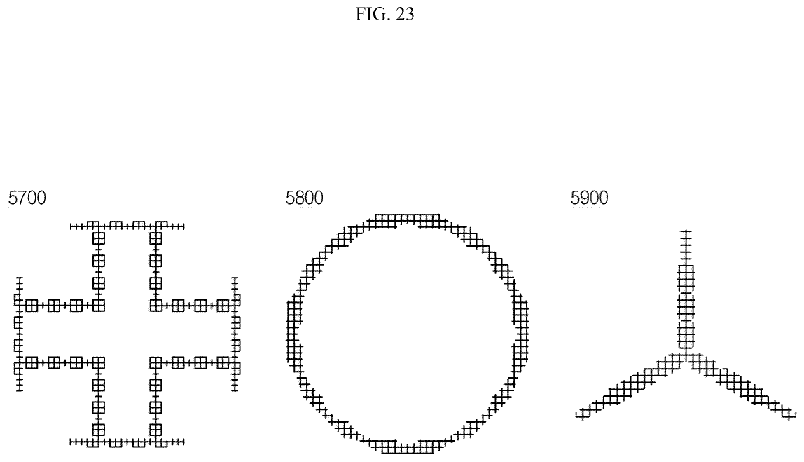

Next, FIG. 23 is a diagram showing a unit cell of various types of FSS to which an uneven mesh pattern according to one embodiment is applied. In particular, FIG. 23 shows a fourth target pattern 5700 in a cross shape, a fifth target pattern 5800 in a circular shape, and a sixth target pattern 5900 in a shape having straight lines extending in three directions from one central point, which are applied to the uneven mesh pattern 17 according to an embodiment of the present document. As illustrated in FIG. 23, the uneven mesh pattern 17 according to an embodiment of the present document can be applied to the pattern structure of the FSS designed in various ways according to a frequency band to be transmitted/blocked.

Therefore, through the FSS including the uneven mesh pattern 17 and the pattern structure utilizing the same according to one embodiment of the present document described above, it is possible to improve visibility problems such as light bleeding while ensuring a constant electromagnetic wave transmission/blocking performance regardless of the position where the pattern is formed.

Although the present invention has been described with reference to the exemplified drawings, it is to be understood that the present invention is not limited to the embodiments and drawings disclosed in this specification, and those skilled in the art will appreciate that various modifications are possible without departing from the scope and spirit of the present invention. Further, although the operating effects according to the configuration of the present invention are not explicitly described while describing an embodiment of the present invention, it should be appreciated that predictable effects are also to be recognized by the configuration.

1. A frequency selective electromagnetic wave transmitting/blocking module comprising:
a substrate; and
a plurality of conductive mesh target patterns on the substrate and including:
a first inner linear region;
a second inner linear region intersecting with the first linear region;
a first outer liner region and a second outer liner region centered on a midpoint of opposite sides from a center of the first inner linear region; and
a third outer liner region and a fourth outer liner region centered on a midpoint of opposite sides from a center of the second inner linear region,
wherein at least one of the inner and outer linear regions includes a conductive uneven mesh pattern having uneven length conductive lines.

2. The frequency selective electromagnetic wave transmitting/blocking module of claim 1, wherein the plurality of conductive mesh target patterns have a same shape.

3. The frequency selective electromagnetic wave transmitting/blocking module of claim 2, wherein the first and second inner linear regions orthogonally intersect in a cross shape and have a common center, and
wherein each of the inner and outer linear regions includes the conductive uneven mesh pattern having the uneven length conductive lines.

4. The frequency selective electromagnetic wave transmitting/blocking module of claim 2, wherein the first and second inner linear regions orthogonally intersect in a cross shape and have a common center,
wherein the first outer liner region and the second outer liner region are centered on the midpoint of opposite sides from the center of the first inner linear region and comprise a fan shape, and
wherein the third outer liner region and the fourth outer liner region centered on the midpoint of opposite sides from the center of the second inner linear region and comprise a same fan shape as the first outer liner region and the second outer liner region.

5. The frequency selective electromagnetic wave transmitting/blocking module of claim 1, wherein the uneven mesh pattern includes a first set of conductive lines extending longer than an adjacent second set of conductive lines.

6. The frequency selective electromagnetic wave transmitting/blocking module of claim 5, wherein the first set of conductive lines comprise protruding conductive lines protruding from the second set of conductive lines.

7. The frequency selective electromagnetic wave transmitting/blocking module of claim 6, wherein a protruding length R1 and a width R2 of the first set of conductive lines including the protruding conductive lines are determined based on an average spacing p between adjacent conductive lines, an average width lw of the conductive lines, and a length W of the second set of conductive lines.

8. The frequency selective electromagnetic wave transmitting/blocking surface of claim 7, wherein the R1 and R2 are determined to obtain a natural number n that satisfies the following equation:
$$( n ‐ 1 ) * p + ( n ) * lw \leq W \leq ( n ) * p + ( n - 1 ) * lw ,$$
to satisfy the following equation:
$$\frac{( n ) * ( p + l w ) - W}{2} \leq R 1 and p + 2 * lw \leq R 2.$$

9. The frequency selective electromagnetic wave transmitting/blocking module of claim 5, wherein the first set of conductive lines includes two conductive lines having a same length.

10. The frequency selective electromagnetic wave transmitting/blocking module of claim 9, wherein the second set of conductive lines include two conductive lines having a same length shorter than the first set of conductive lines.

11. The frequency selective electromagnetic wave transmitting/blocking module of claim 5, wherein the conductive lines in the first and second set of conductive lines are spaced apart from each in equal distances.

12. The frequency selective electromagnetic wave transmitting/blocking module of claim 5, wherein ends of the conductive lines in the first and second set of conductive lines are open and unconnected.

13. The frequency selective electromagnetic wave transmitting/blocking module of claim 1, wherein a center of a corresponding conductive mesh target pattern where the second inner linear region intersects with the first linear region comprises a conductive even mesh pattern having even length conductive lines.

14. The frequency selective electromagnetic wave transmitting/blocking module of claim 13, wherein the even length conductive lines in the first linear region of the conductive even mesh pattern have ends connected to each other.

15. The frequency selective electromagnetic wave transmitting/blocking module of claim 14, wherein the even conductive lines in the second linear region of the conductive even mesh pattern have ends connected to each other.

16. The frequency selective electromagnetic wave transmitting/blocking module of claim 1, wherein at least one of the inner linear region and the outer linear region includes a conductive even mesh pattern having even length conductive lines.

17. The frequency selective electromagnetic wave transmitting/blocking module of claim 1, wherein the first outer liner region, the second outer liner region, the third outer liner region and the fourth outer liner region include the conductive uneven mesh pattern having uneven length conductive lines, and
wherein the first inner liner region and the second inner liner region include a conductive even mesh pattern having even length conductive lines.

18. The frequency selective electromagnetic wave transmitting/blocking module of claim 1, wherein the uneven mesh pattern is formed by cutting a shape of a corresponding target pattern from a larger even mesh pattern so that a cross shape pattern is repeatedly arranged by cutting all sides around a point where rows and columns of the larger even mesh pattern meet.

19. The frequency selective electromagnetic wave transmitting/blocking module of claim 1, further comprising:
a PET (Polyethylene Terephthalate) film between the substrate and the conductive mesh target patterns.

20. The frequency selective electromagnetic wave transmitting/blocking module of claim 1, wherein the substrate comprises glass or an antenna.
